(19) United States
(12) Patent Application Publication
(10) Pub. No.: US 2015/0312920 A1
(43) Pub. Date: Oct. 29, 2015

(54) METHOD AND APPARATUS FOR USE IN USER EQUIPMENT CONFIGURED WITH EPDCCH FOR PROVIDING DOWNLINK RADIO LINK CONDITION

(71) Applicant: ALCATEL LUCENT, Boulogne Billancourt (FR)

(72) Inventors: Teck Hu, Melbourne, FL (US); Zheng Liu, Shanghai (CN); Qi Jiang, Shanghai (CN)

(73) Assignee: ALCATEL LUCENT, Boulogne Billancourt (FR)

(21) Appl. No.: 14/650,135

(22) PCT Filed: Dec. 7, 2012
(86) PCT No.: PCT/CN2012/086187

§ 371 Date: Jun. 5, 2015

(51) Int. Cl. H04W 72/08; H04L 5/00; H04W 72/04; H04W 24/10

(52) U.S. Cl. CPC H04W 72/085; H04W 24/10; H04L 5/0057; H04W 72/042; H04W 88/08

(57) ABSTRACT

The invention provides a method for use in a user equipment configured with EPDCCH, the method comprising: measuring downlink radio link quality corresponding to UE-specific search space in EPDCCH; and sending an EPDCCH CQI to a serving base station to indicate the measured downlink radio link quality. The invention further provides a method for use in a user equipment configured with EPDCCH, the method comprising: measuring downlink radio link quality corresponding to UE-specific search space in EPDCCH; and sending an EPDCCH failure indicator to a serving base station when the measured downlink radio link quality does not meet a predetermined condition. The invention further provides a method for use in a user equipment configured with EPDCCH, the method comprising: measuring downlink radio link quality corresponding to common search space in PDCCH on frames where EPDCCH is configured; and triggering radio link failure when the measured downlink radio link quality does not meet a predetermined condition.

### FIELD OF THE INVENTION

The application relates to communication systems.

### BACKGROUND OF THE INVENTION

Enhanced Physical Downlink Control Channel (EPDCCH) is a new Work Item in 3GPP Release 11, and currently Radio Link Monitoring (RLM) has been identified as the main issue to be resolved.

Since 3GPP Release 8, RLM is determined by the user equipment (UE) monitoring the downlink radio link quality based on the Cell-specific Reference Signal (CRS) in order to measure the downlink radio link quality of the serving cell. This UE behavior and detail procedures are described in TS 36.213.

In existing Release 10, the Common Search Space (CSS) and the UE-specific Search Space (USS) are monitored in PDCCH for RLF. Release 10 behavior is followed where UE decoding of the USS and CSS forms PDCCH BLER of a hypothetical transmission.

With the newly agreed design of EPDCCH, UE monitors USS on EPDCCH and CSS on PDCCH in the subframes configured for EPDCCH. And, UE continues to monitor and decode both CSS and USS in the legacy PDCCH in the subframes configured for PDCCH.

When EPDCCH is configured, one approach is to design UE RLF entirely on the PDCCH to maintain as much commonality with Release 10 operations as possible. However, we have the following scenarios that are new with EPDCCH.
PDCCH fails and EPDDCH passes: No additional steps need to be taken as failing the PDCCH would result in failed decoding of CSS carrying the essential DCIs for the pertinent system information etc. Hence, the Radio Link Failure (RLF) is declared, similar to Release 10 RLF behavior.
PDCCH passes and EDPCCH fails: This would have been a straightforward solution since the EPDCCH is treated like a PDSCH subjected to the eNodeB scheduling process. However, in the extreme case, it is possible that the eNodeB always re-schedules the UE by EPDCCH unsuccessfully for a long time as it does not know the EPDCCH fails.

Therefore, for the second scenario, there is a need of proposing a solution to feed back downlink radio link condition of the EPDCCH.

### OBJECT AND SUMMARY OF THE INVENTION

The main idea of this invention is that for UE configured with EPDCCH, UE decodes USS in EPDCCH (i.e., measuring downlink radio link quality corresponding to USS in EPDCCH) and send an EPDCCH CQI to a serving base station to indicate the measured downlink radio link quality, or send an EPDCCH failure indicator to a serving base station when the measured downlink radio link quality does not satisfy a predetermined condition.

With the EPDCCH CQI from UE, the base station can know the current downlink radio link quality and then perform link adaptation or adjust other EPDCCH configuration parameters if required. Likewise, with the EPDCCH failure indicator from UE, the base station can know that the current downlink radio link quality is not quite well and consequently re-configure the EPDCCH transmission.

In an alternative embodiment, UE may only decode CSS in PDCCH and trigger RLF when the decoding of CSS in PDCCH is failed. In this case, failure of decoding of USS does not result in RLF.

For UE not configured with EPDCCH, the legacy behavior of decoding both CSS and USS can be maintained.

In one aspect of the invention, there is provided a method for use in a user equipment configured with EPDCCH, the method comprising: measuring downlink radio link quality corresponding to UE-specific search space in EPDCCH; and sending an EPDCCH CQI to a serving base station to indicate the measured downlink radio link quality.

Advantageously, the EPDCCH CQI comprises the desired number of PRB pairs in the configured EPDCCH set, PRB positions and the desired aggregation level of eCCE.

In another aspect of the invention, there is provided a method for use in a user equipment configured with EPDCCH, the method comprising: measuring downlink radio link quality corresponding to UE-specific search space in EPDCCH; and sending an EPDCCH failure indicator to a serving base station when the measured downlink radio link quality does not meet a predetermined condition.

In another aspect of the invention, there is provided a method for use in a user equipment configured with EPDCCH, the method comprising: measuring downlink radio link quality corresponding to common search space in PDCCH on subframes where EPDCCH is configured; and triggering radio link failure when the measured downlink radio link quality does not meet a predetermined condition.

In another aspect of the invention, there is provided a method for use in a base station, the method comprising: receiving an EPDCCH CQI from a user equipment configured with EPDCCH, the EPDCCH CQI indicating downlink radio link quality measured by the user equipment.

In another aspect of the invention, there is provided a method for use in a base station, the method comprising: receiving an EPDCCH failure indicator from a user equipment configured with EPDCCH.

In another aspect of the invention, there is provided an apparatus for use in a user equipment configured with EPDCCH, the apparatus comprising: a measuring unit configured to measure downlink radio link quality corresponding to UE-specific search space in EPDCCH; and a sending unit configured to send an EPDCCH CQI to a serving base station to indicate the measured downlink radio link quality.

In another aspect of the invention, there is provided an apparatus for use in a user equipment configured with EPDCCH, the apparatus comprising: a measuring unit configured to measure downlink radio link quality corresponding to UE-specific search space in EPDCCH; and a sending unit configured to send an EPDCCH failure indicator to a serving base station when the measured downlink radio link quality does not meet a predetermined condition.

In another aspect of the invention, there is provided an apparatus for use in a user equipment configured with EPDCCH, the apparatus comprising: a measuring unit configured to measure downlink radio link quality corresponding to common search space in PDCCH on subframes where EPDCCH is configured; and a triggering unit configured to trigger radio link failure when the measured downlink radio link quality does not meet a predetermined condition.

In another aspect of the invention, there is provided an apparatus for use in a base station, the apparatus comprising: a receiving unit configured to receive an EPDCCH CQI from a user equipment configured with EPDCCH, the EPDCCH CQI indicating downlink radio link quality.

In another aspect of the invention, there is provided an apparatus for use in a base station, the apparatus comprising: a receiving unit configured to receive an EPDCCH failure indicator from a user equipment configured with EPDCCH.

### BRIEF DESCRIPTION OF THE DRAWINGS

The invention is explained in further detail, and by way of example, with reference to the accompanying drawings wherein:

FIG. 1 shows a flow chart of a method of feeding back downlink radio link condition when EPDCCH is configured according to one embodiment of the invention;

FIG. 2 shows a flow chart of a method of feeding back downlink radio link condition when EPDCCH is configured according to another embodiment of the invention.

Throughout the above drawings, like reference numerals will be understood to refer to like, similar or corresponding features or functions.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Hereinafter, the technical solutions of foregoing aspects of the invention will be described in great detail. It is to be noted that the following embodiments refer to the UE configured with EPDCCH.

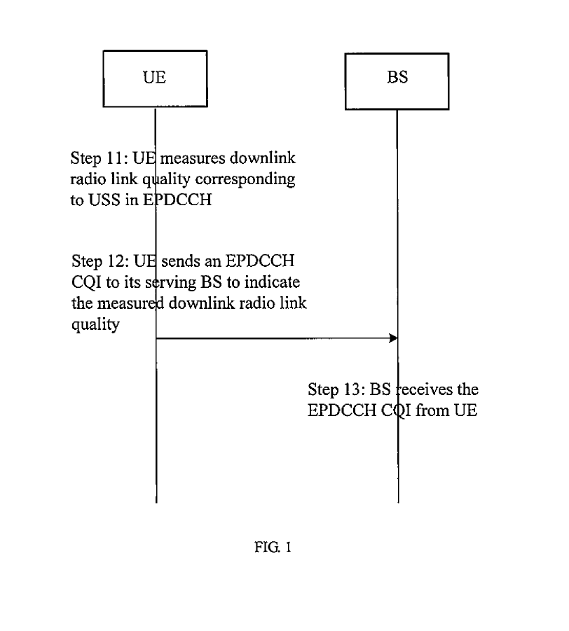

In one embodiment, referring to FIG. 1, UE measures downlink radio link quality corresponding to USS in EPDCCH in Step 11. Then UE sends an EPDCCH CQI to its serving base station (BS) in Step 12. The EPDCCH CQI is used for indicating the measured downlink radio link quality.

Next, in Step 13, BS receives the EPDCCH CQI from UE. From the received EPDCCH CQI, BS can know the current downlink radio link quality and may perform link adaptation or re-configure the EPDCCH transmission if necessary.

The EPDCCH CQI may for example include UE's desired number ‘K’ of PRB pairs and desired aggregation level ‘L’ of eCCE. In one example, the value of ‘K’ and ‘L’ may be designed on the basis that 1% BLER (block error rate) is achieved.

The solution of this embodiment allows for reduced RLF since the modulation (eCCE) of EPDCCH is more robust resulting in smaller BLER. In addition, unlike the lack of CQI for PDCCH, the EPDCCH has CQI which facilitates a much more optimized adaptation for the EPDCCH compared to the legacy PDCCH.

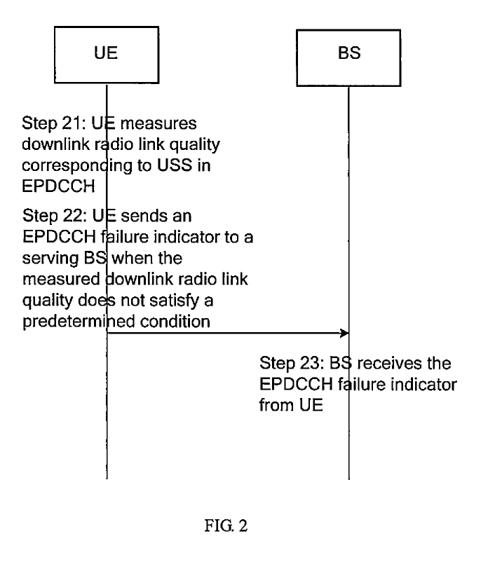

In another embodiment, referring to FIG. 2, UE measures downlink radio link quality corresponding to USS in EPDCCH in Step 21. Then UE sends an EPDCCH failure indicator to a serving base station (BS) when the measured downlink radio link quality does not satisfy a predetermined condition (i.e., the failure of decoding USS) in Step 22. Alternatively, upon recognizing the failure of decoding USS, UE can initiate connection re-establishment and then report RLF to BS.

The situation that the measured downlink radio link quality does not satisfy a predetermined condition can be the BLER of EPDCCH transmission exceeding a predetermined BLER threshold.

Next, in Step 23, BS receives the EPDCCH failure indicator from UE. From the received EPDCCH failure indicator, BS can know that the current downlink radio link quality is not good and may perform link adaptation.

With the foregoing two embodiments, the scenario where the decoding of USS in EPDCCH fails continuously and the network is unable to terminate the radio link can be effectively prevented.

Besides the foregoing two embodiments where USS in EPDCCH is monitored to feed back downlink radio link condition, in a further embodiment, UE can only decode CSS in PDCCH and trigger RLF when the decoding of CSS in PDCCH is failed.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

What is claimed is:

1. A method for use in a user equipment configured with EPDCCH, the method comprising:
measuring downlink radio link quality corresponding to UE-specific search space in EPDCCH;
sending an EPDCCH CQI to a serving base station to indicate the measured downlink radio link quality.

2. The method of claim 1, wherein the EPDCCH CQI comprises the desired number of PRB pairs, PRB positions and the desired aggregation level of eCCE.

3. A method for use in a user equipment configured with EPDCCH, the method comprising:
measuring downlink radio link quality corresponding to UE-specific search space in EPDCCH;
sending an EPDCCH failure indicator to a serving base station when the measured downlink radio link quality does not meet a predetermined condition.

4. A method for use in a user equipment configured with EPDCCH, the method comprising:
measuring downlink radio link quality corresponding to common search space in PDCCH on frames where EPDCCH is configured;
triggering radio link failure when the measured downlink radio link quality does not meet a predetermined condition.

5. A method for use in a base station, the method comprising:
receiving an EPDCCH CQI from a user equipment configured with EPDCCH, the EPDCCH CQI indicating downlink radio link quality measured by the user equipment.

6. A method for use in a base station, the method comprising:
receiving an EPDCCH failure indicator from a user equipment configured with EPDCCH.

7. An apparatus for use in a user equipment configured with EPDCCH, the apparatus comprising:
a measuring unit configured to measure downlink radio link quality corresponding to UE-specific search space in EPDCCH;
a sending unit configured to send an EPDCCH CQI to a serving base station to indicate the measured downlink radio link quality.

8. The apparatus of claim 1, wherein the EPDCCH CQI comprises the desired number of PRB pairs, PRB positions and the desired aggregation level of eCCE.

9. An apparatus for use in a user equipment configured with EPDCCH, the apparatus comprising:
a measuring unit configured to measure downlink radio link quality corresponding to UE-specific search space in EPDCCH;
a sending unit configured to send an EPDCCH failure indicator to a serving base station when the measured downlink radio link quality does not meet a predetermined condition.

10. An apparatus for use in a user equipment configured with EPDCCH, the apparatus comprising:
a measuring unit configured to measure downlink radio link quality corresponding to common search space in PDCCH on subframes where EPDCCH is configured;
a triggering unit configured to trigger radio link failure when the measured downlink radio link quality does not meet a predetermined condition.

11. An apparatus for use in a base station, the apparatus comprising:
a receiving unit configured to receive an EPDCCH CQI from a user equipment configured with EPDCCH, the EPDCCH CQI indicating downlink radio link quality.

12. An apparatus for use in a base station, the apparatus comprising:
a receiving unit configured to receive an EPDCCH failure indicator from a user equipment configured with EPDCCH.
